(19) United States
(12) Patent Application Publication
(10) Pub. No.: US 2016/0008699 A1
(43) Pub. Date: Jan. 14, 2016

(54) WHEEL BEARING ASSEMBLY FOR GENERATION OF ELECTRICITY

(71) Applicant: SUNSET SKATEBOARD COMPANY, Newport Beach, CA (US)

(72) Inventor: Jeremy FISSELL, San Luis Obispo, CA (US)

(21) Appl. No.: 14/794,503

(22) Filed: Jul. 8, 2015

Related U.S. Application Data
(60) Provisional application No. 62/022,175, filed on Jul. 8, 2014.

(51) Int. Cl. A63C 17/22; H02K 7/18; H02K 7/08; F16C 41/00; A63C 17/26

(52) U.S. Cl. CPC A63C 17/22; F16C 41/004; A63C 17/26; H02K 7/08; H02K 7/1846

(57) ABSTRACT

A wheel assembly is provided that includes a first bearing and a second bearing that is axially aligned with the first bearing to form a hub for an axle. The first bearing includes: an outer race having an inner surface with respect to the axial alignment of the first bearing and the second bearing and an inner race having a portion axially extending beyond the inner surface of the outer race to at least partially define the hub. The wheel assembly further includes a magnetic unit securely coupled with the portion of the inner race axially extending beyond the inner surface of the outer race; and a wheel coupled with the respective outer race of the first bearing, the wheel having one or more wire coils that are configured to generate electricity with the magnetic unit when the wheel spins.

### CROSS REFERENCE TO RELATED APPLICATIONS

The present application claims priority under 35 U.S.C. §119(e) to U.S. Provisional Patent Application No. 62/022,175 filed Jul. 8, 2014, which is incorporated herein by reference in its entirety.

### TECHNICAL FIELD

The disclosed embodiments relate generally to a self-illuminating skateboard.

### BACKGROUND

In recent years, skateboarding has increased in popularity as a recreational activity. Skateboards have found other uses as well. For instance, some messengers and couriers use skateboards as a mode of transportation. Frequently these skateboards are used in the evenings or at night when, due to poor visibility there is greater likelihood of accidents and injuries resulting from their use. In order to make the device, and hence the person riding thereon, safely visible, it has been proposed to use an illuminating device in conjunction with the skateboard. Thus, U.S. Pat. No. 4,336,573 discloses an illuminated skateboard comprising a person carrying platform under which is a pair of axles supported from the platform and rolling wheels engaged thereon. A power source is disposed on the bottom surface of the platform and is operatively connected to a light source so as to illuminate the wheels of the skateboard. The wheels are made from translucent material in order to transmit the light generated by the power source along the outer faces of the wheels.

Such illumination of skateboards has only increased their popularity. However, to date, illuminated skateboard have come in two types: those in which the illumination source is in the wheels and those in which the illumination source it built into the board. In order to provide further safety, as well as to differentiate over simple older methods of illumination, what is needed in the art are new ways to illuminate skateboards such that light is distributed in new and attention garnering ways. Such skateboards will not only be safer, they will provide the ability to distinguish over older skateboard designs.

### SUMMARY

The disclosed wheel assemblies include a mechanism for generating electricity from, for example, a spinning wheel without degrading the performance of the wheel. The generated electricity is optionally used to illuminate a skateboard, thus addressing the problems with conventional skateboards noted above. In particular, a wheel assembly is provided that includes a first bearing and a second bearing that is axially aligned with the first bearing to form a hub for an axle. The first bearing includes an outer race having an inner surface with respect to the axial alignment of the first bearing and the second bearing and an inner race having a portion axially extending beyond the inner surface of the outer race to at least partially define the hub. The wheel assembly also includes a magnetic unit securely coupled with the portion of the inner race axially extending beyond the inner surface of the outer race and a wheel coupled with the respective outer race of the first bearing. The wheel has one or more wire coils that are configured to generate electricity with the magnetic unit when the wheel spins.

In some embodiments, the second bearing includes an inner race. When in use, the inner race of the second bearing is securely coupled with the inner race of the first bearing by an axle unit that includes an axle disposed within the hub and two or more mechanical fasteners along the axle on each side of the hub.

In some embodiments, the wheel assembly is for a skateboard.

In some embodiments, the wheel assembly further includes a plurality of light sources configured to produce light using the generated electricity.

In some embodiments, the wheel includes a body made of a transparent material and the plurality of light sources is disposed within the body of the wheel so as to shine light outwardly from the wheel.

In some embodiments, the portion of the inner race includes an outer annular surface made of a first material and the magnetic unit includes an inner annular surface made of a second material different from the first material. The inner annular surface of the magnetic unit is securely coupled with the outer annular surface of the portion of the inner race. In some embodiments, inner annular surface of the magnetic unit is press-fit onto the outer annular surface of the portion of the inner race. In some embodiments, the first material is harder than the second material.

In some embodiments, the magnetic unit is rotationally fixed with respect to the inner race. The magnetic unit together with the inner race is free to rotate with respect to the outer race.

Further, another wheel assembly is provided for generating electricity, e.g., from a spinning wheel. The wheel assembly includes a first bearing and a second bearing that is axially aligned with the first bearing to form a hub for an axle. Each of the first bearing and the second bearing includes an outer race having an inner surface with respect to the axial alignment of the first bearing and the second bearing. Each of the first bearing and the second bearing also includes an inner race that at least partially defines the hub. The wheel assembly further includes a spacer disposed between the respective inner surfaces of the outer race of the first bearing and the outer race of the second bearing. The spacer includes a cylinder made of a first material. The cylinder is axially aligned with the first bearing and the second bearing. The spacer also includes a magnetic unit securely coupled with an outer annular surface of the cylinder. An inner angular surface of the magnetic unit is made of a second material different from the first material. The wheel further includes a wheel coupled with the respective outer races of the first bearing and the second bearing. The wheel has one or more wire coils that are configured to generate electricity with the magnetic unit when the wheel spins. When in use, the spacer is securely coupled with the inner races of the first bearing and the second bearing to further define the hub.

In some embodiments, the wheel assembly is for a skateboard.

In some embodiments, the wheel assembly further includes a plurality of light sources configured to produce light using the generated electricity.

In some embodiments, the wheel includes a body made of a transparent material and the plurality of light sources is disposed within the body of the wheel so as to shine light outwardly from the wheel.

In some embodiments, the inner annular surface of the magnetic unit is press-fit onto the outer annular surface of the portion of the inner race.

In some embodiments, the first material is harder than the second material.

In some embodiments, the magnetic unit is rotationally fixed with respect to the inner race of each of the first bearing and the second bearing. The magnetic unit together with the inner race of each respective bearing is free to rotate with respect to the outer race of the respective bearing.

### BRIEF DESCRIPTION OF THE DRAWINGS

FIG. 1 is a perspective view of an embodiment of skateboard in accordance with an embodiment of the present disclosure, in accordance with some embodiments.

FIG. 2 is a first side view of the skateboard of FIG. 1, in accordance with some embodiments.

FIG. 3 is a second side view of the skateboard of FIG. 1, in accordance with some embodiments.

FIG. 4 is a top view of the skateboard of FIG. 1, in accordance with some embodiments.

FIG. 5 is a bottom view of the skateboard of FIG. 1, in which the dashed lines are showing topological features of the top side of the transparent board, in accordance with some embodiments.

FIG. 6 is a front view of the skateboard of FIG. 1, in accordance with some embodiments.

FIG. 7 is a back view of the skateboard of FIG. 1, in which the dashed lines are showing topological features of the top side of the transparent board, in accordance with some embodiments.

FIG. 8 is another top view of the skateboard of FIG. 1, in which there is graphic on the bottom surface of the transparent or translucent plastic deck of the skateboard, and in which the graphic is illuminated, in a manner visible from the top surface of the deck through the transparent or translucent plastic deck, in accordance with some embodiments.

FIG. 9 is a perspective view of a wheel of the skateboard of FIG. 1, in accordance with some embodiments.

FIG. 10 is a first side view of the wheel of the skateboard of FIG. 1, in accordance with some embodiments.

FIG. 11 is a second side view of the wheel of the skateboard of FIG. 1, in accordance with some embodiments.

FIG. 12 is an illustration of an inner race of a bearing, in accordance with some embodiments.

FIG. 13 is an expanded illustration of a hub, in accordance with some embodiments.

FIG. 14 is an expanded illustration of another hub, in accordance with some embodiments.

FIG. 15 is an illustration of a wheel that receives a hub, in accordance with some embodiments.

Like reference numerals refer to corresponding parts throughout the drawings.

### DESCRIPTION OF EMBODIMENTS

It will also be understood that, although the terms “first,” “second,” etc. may be used herein to describe various elements, these elements should not be limited by these terms. These terms are only used to distinguish one element from another. For example, a first wheel could be termed a second wheel, and, similarly, a second wheel could be termed a first wheel, without changing the meaning of the description, so long as all occurrences of the “first wheel” are renamed consistently and all occurrences of the second wheel are renamed consistently. The first wheel and the second wheel are both wheels, but they are not the same wheel.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The term “deck” as used herein means the platform of a skateboard. There are many kinds of decks, and they may be composed of many different materials. They are rigid so that they may hold the weight of the rider, and are also preferably somewhat flexible to absorb shock for a smoother ride.

The term “truck” as used herein means an assembly attached to the deck that holds the wheels of the skateboard. It typically comprises a base and a hanger. Typically, the base is fixedly attached to the deck, and the hanger is a movable portion to which the wheels are attached via axles.

Reference will now be made in detail to various embodiments, examples of which are illustrated in the accompanying drawings. In the following detailed description, numerous specific details are set forth in order to provide a thorough understanding of the invention and the described embodiments. However, the invention may be practiced without these specific details. In other instances, well-known methods, procedures, components, and circuits have not been described in detail so as not to unnecessarily obscure aspects of the embodiments.

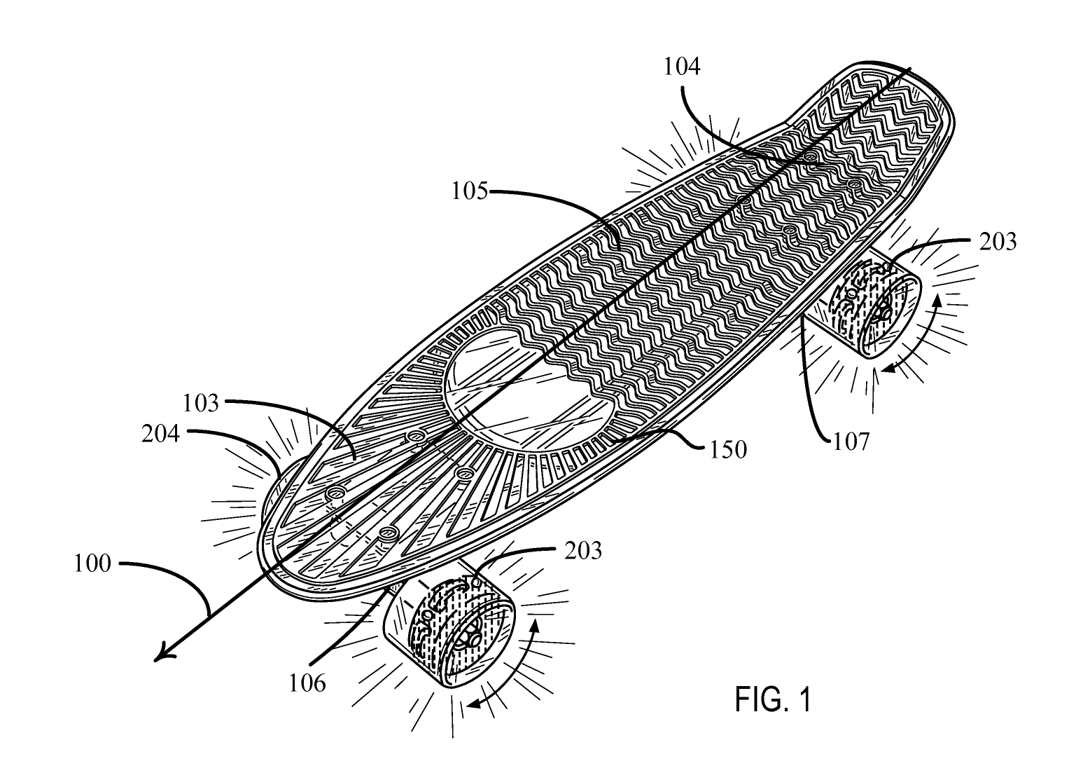

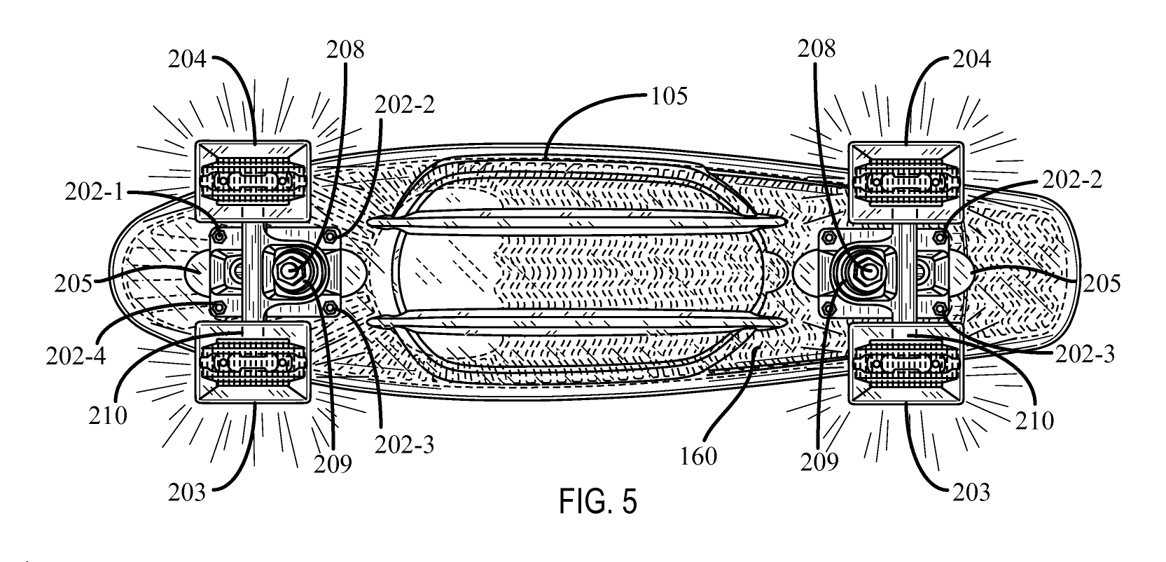

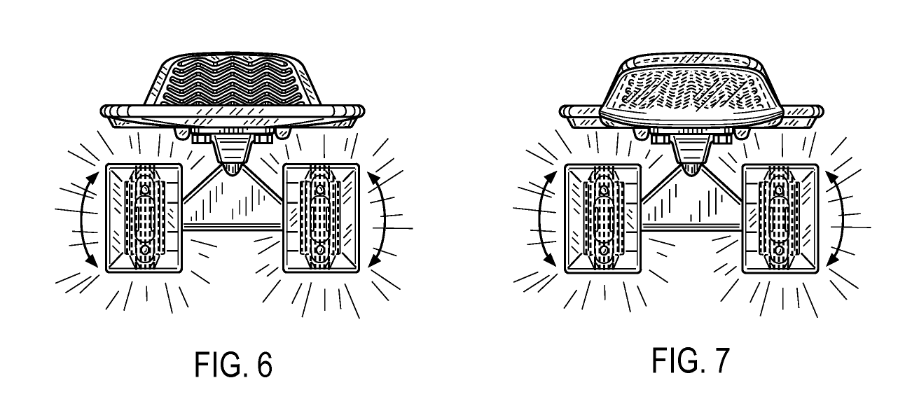

FIG. 1 shows a skateboard in accordance with the present disclosure from a perspective view. This skateboard comprises a deck 105 and wheel assemblies 106 and 107. The skateboard is elongated along a longitudinal axis 100, having front 103 and rear 104 portions with respect to the longitudinal axis. The deck has a top surface 150 and a bottom surface 160 (FIG. 5). Other skateboard configurations are possible, including boards with three or more wheel assemblies, or a single wheel assembly, which may make use of the wheel assemblies and wheels disclosed herein.

Advantageously, deck 105 is transparent or translucent and is made of plastic. In this way, wheels 203/204 and the lower surface 160 are visible from the top surface of the deck through the transparent or translucent plastic deck. In some embodiments, the skateboard includes a graphics layer on the top surface 150 or the bottom surface 160 (FIG. 5) of the transparent or translucent plastic deck 105. The graphics layer is illuminated, in a manner visible from the top surface 150 of the deck through the transparent or translucent plastic deck, by a plurality of light emitting devices from the respective wheels when the corresponding wheel generators generate electricity, as described below. In some embodiments, the graphics layer includes an adhesive surface having a graphic printed (e.g., digitally printed) thereon and an adhesive (e.g., a glue, cement, or other binding agent) applied thereon and the adhesive surface is adhesively affixed to the top or bottom surface of the transparent or translucent plastic deck 105. In some embodiments, the graphics layer is on the top surface 150 and is a grip tape having a rough surface (e.g., a high friction gripping surface) opposite the adhesive surface. Stated another way, in some embodiments, the graphics layer

FIG. 5 is a bottom view of the skateboard of FIG. 1 and shows the wheel assemblies 106 and 107 in greater detail. Each assembly includes a base 201, which is attached to the deck 105 through bolts 202. Each wheel assembly 106/107 has two wheels 203 and 204, a bumper yoke 205, a kingpin 208 that is attached to base 201 via a retaining ring 209, and an axle 210. Alternative arrangements of the above components may be suggested to one of skill in the art.

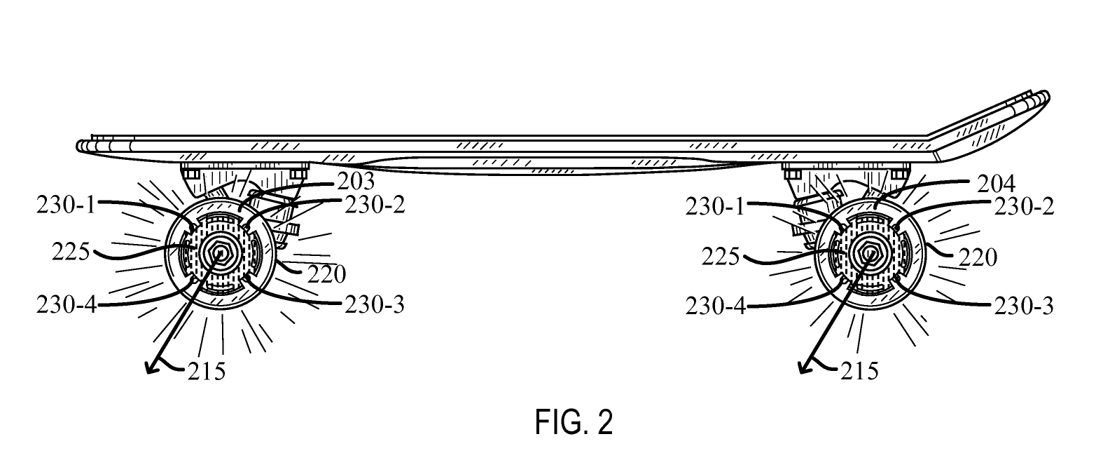

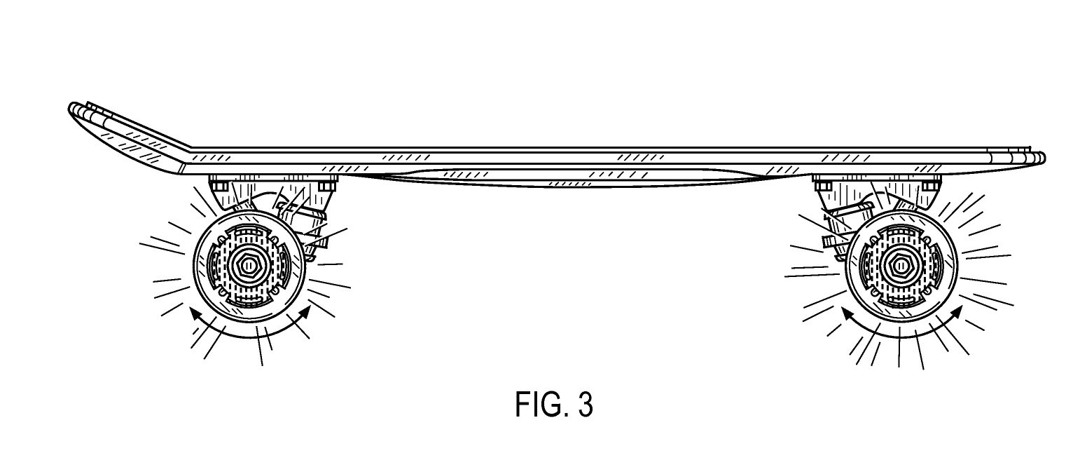

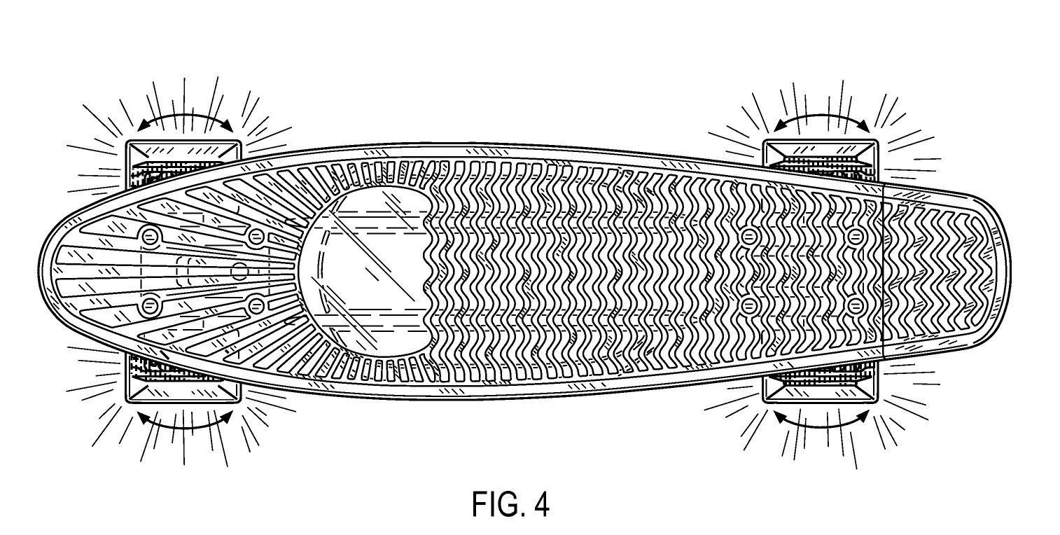

Referring to FIGS. 2, 9, 10, and 11, wheels 203/204 each include (i) a rotational axis 215 aligned with the associated axle 210 (not shown in FIG. 2 or 9-11, see FIG. 5) of the respective wheel, (ii) a transparent or translucent wheel covering 220 having a surface substantially conforming to a mathematical surface defined by revolving a continuous, smooth curve about the rotational axis, and (iii) a wheel interior 225 defined by the rotational axis 215 and the transparent or translucent wheel covering 220. The wheel interior 225 houses (i) a wheel generator (not shown) configured to generate electricity and (ii) a plurality of light emitting devices 230 electrically coupled to the wheel generator. Advantageously, the plurality of light emitting devices 230 emits light when the corresponding wheel generators generate electricity.

An example of wheel generators that can be used in the wheels 203/204 include those described in U.S. Pat. Nos. 4,298,910; 4,648,410; 5,580,093; 5,810,450; and 6,398,395, each of which is hereby incorporated by reference herein in its entirety. In general, such wheel generators make use of electromagnetic induction from the rotation of the wheels about their respective rotational axes. Advantageously, in some disclosed embodiments herein, the plurality of light emitting devices 230 is a plurality of light emitting diodes that, when powered by electricity from the corresponding wheel generator, emit a light having a color selected from the group consisting of green, blue, white, red, pink, purple, yellow and orange.

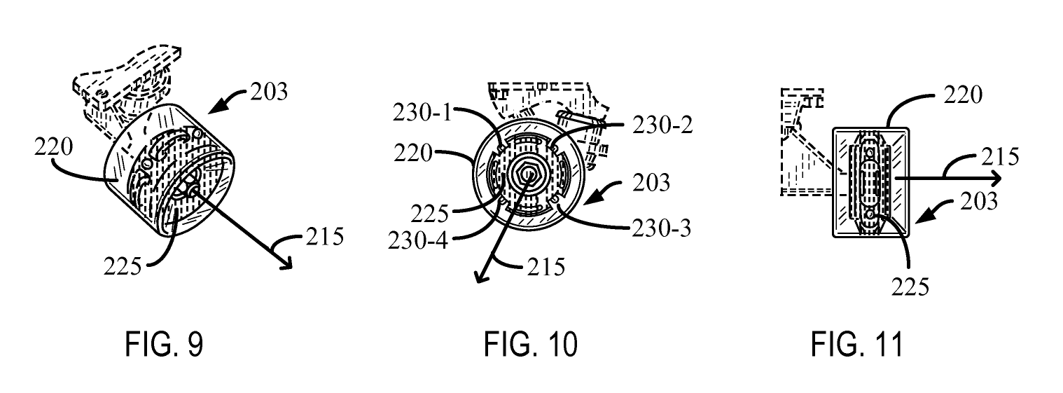

In some embodiments, the plurality of light emitting devices 230 is four light emitting diodes evenly spaced around a corresponding rotational axis. In some embodiments, the plurality of light emitting devices 230 is two, three, four, five, six, seven, eight, nine, or ten light emitting diodes evenly spaced around a corresponding rotational axis. In some embodiments, there are one, two or three or more light emitting diodes at each of two, three, four, or five or more positions about the rotational axis of the wheel. As shown in FIG. 9, there are four light emitting diodes at each of four evenly spaced positions about the rotational axis of the wheel.

In some embodiments, in order to get emission of a sufficiently bright purple light, the plurality of light emitting devices 230 collectively emit the purple light through the contribution of first and second pink light emitting diodes and first and second blue light emitting diodes, where the pink and blue diodes are alternatively but evenly spaced about the rotational axis of the wheel.

In some embodiments, the wheel covering 220 may be tapered, so that the slope of the function representing the diameter as a profile versus the distance from the inside edge of the wheel may have a decreasing slope over at least part of its profile, particularly as the wheel tapers toward its outside edge. Such wheels are disclosed in United States Patent Publication No. 2013/0026723, which is hereby incorporated by reference herein in its entirety. From the point of its maximum to the outside edge, this function is preferably monotonically decreasing. It may preferably be monotonically decreasing for essentially the entire length of the wheel, except perhaps for the inside of the wheel, which may in one embodiment be slightly rounded or beveled, which makes little difference to the overall performance of the wheel.

The continuous, smooth curve of wheel covering 220 may take a variety of shapes. Preferably, it may be an arc of a circle. The diameter at the edge of the wheel may be substantially smaller than the maximum diameter. The wheel is preferably elongated so that the dimensions of its width are about the same as its diameter, or it is wider than its diameter.

In some embodiments, the wheel covering 220 is described by reference to an ideal mathematical surface to which the wheel substantially conforms. Due to machining, molding, or other manufacturing variations, or because of the inherent roughness of the surface, or because of wear-and-tear, the wheel like any other physical object is not precisely a mathematical object, and may vary on the order of several millimeters from any ideally-defined shape. Similarly, two ideal shapes may be substantially, but not identically, the same, and still provide essentially the same performance, stability, and maneuverability to the rider, such that the rider does not detect a significant or noticeable difference during usage. Such differences may be on the order of at least several millimeters. Minor changes in dimension or scale, or slightly lengthening scale in one dimension while keeping the scale in another dimension the same or less, may also provide an insubstantial change to the ideal mathematical shape.

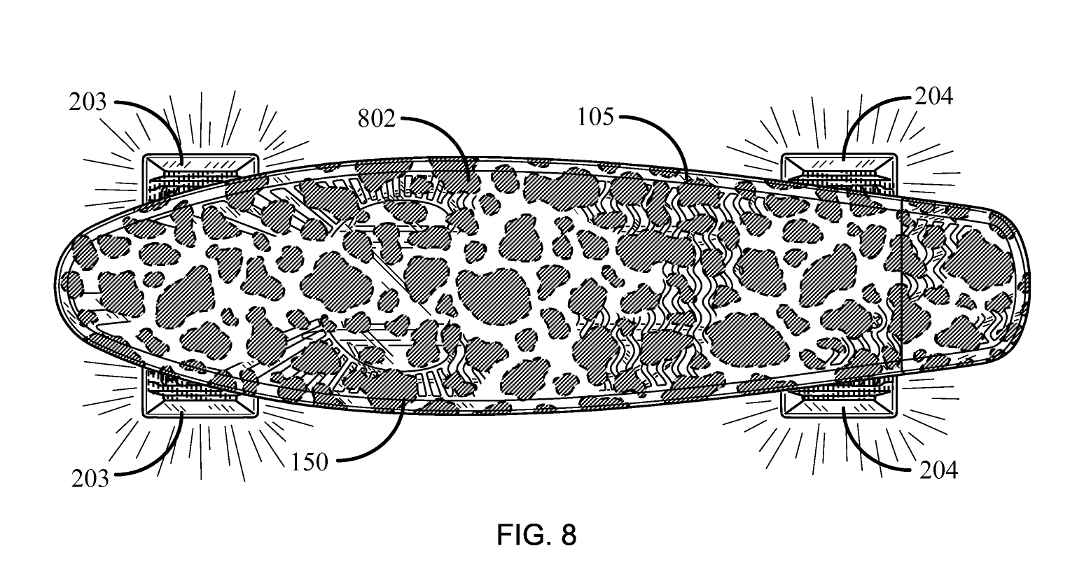

Advantageously, the disclosed skateboards include a graphic on the top surface 150 or the bottom surface 160 of the deck 105. Because the skateboard is transparent or translucent, this graphic is illuminated, in a manner visible from the top surface 150 of the deck 105 through the deck, by each respective plurality of light emitting devices 230 when the corresponding wheel generators generate electricity. In typical embodiments, such wheel generators generate electricity when the wheels 203/204 are rotating about their respective rotational axes 215. FIG. 8 illustrates how the light from the wheels 203/204 illuminate a graphic 802 on the bottom surface 160 of deck 105 in a manner visible from the top surface 150 of the deck 105 because the deck is transparent or translucent. In FIG. 802, the graphic 802 has a classic cow print texture. In some embodiments, the graphic comprises a repeating pattern such as depictions of small animals or other forms of classic prints. In some embodiments, the graphic comprises a message or a logo. For example, the graphic could be a company logo. The graphic comprises a message or a logo. In some embodiments, the graphic comprises a corporate logo or a trademark. In some embodiments, the graphic is on the bottom surface 160 and is inverted.

In some embodiments, the graphic is on the bottom surface 160 of the deck 105 and the graphic includes a first portion that is opaque and a second portion that is transparent or translucent. Referring to FIG. 8 for illustration, in some embodiments the dark portions of the cow print graphic 802 are opaque whereas the light portions are transparent or translucent. The presence of opaque portions of the graphic 802 do not permit light through the top surface 150 and thus the transparent or translucent portions that do permit light through the top surface 150 are enhanced by the dart contrast of the opaque portions of the graphic. Although a cow print graphic 802 of FIG. 8 is used to illustrate this feature, it will be appreciated that the transparent or translucent portions of the graphic in such embodiments could spell out a word or phrase while the opaque portions of the graphic serves as the background to this word or phrase. In fact, in some embodiments, the graphic is on the bottom surface 160 of the deck 105 and the graphic includes an inverted message that is legible when viewed through the top surface 150 of the deck 105.

In some embodiments, the graphic occupies the entire bottom surface 160 and includes an opaque border region and a transparent or translucent interior region. In some such embodiments the transparent or translucent interior region comprises a picture, a message, a word, a trademark, or a logo.

In some embodiments, the graphic occupies only a portion of the bottom surface 160, such as a center portion of the bottom surface, and includes an opaque border region and a transparent or translucent interior region. In some such embodiments the transparent or translucent interior region comprises a picture, a message, a word, a trademark, or a logo.

In some embodiments, the plurality of light emitting devices 230 comprises a plurality of light emitting diodes that, when powered by the wheel generator, emits an ultraviolet light. By its nature, ultraviolet light is not visible to the human eye. However, advantageously, in some such embodiments the transparent or translucent deck 105 and/or the wheel covering is 220 embedded with an infused glow powder that emits a visible light responsive to the ultraviolet light. In some such embodiments, the skateboard further includes a graphic on the top surface 150 or the bottom surface 160 of the deck 105.

In embodiments that make use of ultraviolet light, the ultraviolet light can charge a printed ink or paint infused with glow powder (translucent, transparent, or opaque) thereby causing the glow powder to emit visible light, charge a plastic or rubber (like polyurethane, known as “PU”) infused with glow powder thereby causing the glow powder t emit visible light, or illuminate a fluorescent color ink, paint, plastic, rubber, etc., thereby causing the fluorescent color ink, paint, plastic, or rubber to emit a visible light.

Regarding fluorescence, this type of luminescence occurs when some form of radiation, such as ultraviolet light, causes an object to glow. For example, fluorescent papers and poster boards glow in the daylight. They may seem to glow even brighter under black light (ultraviolet), but in either case, as soon as the light is removed, the glow stops. Fluorescent objects do not glow in the dark all by themselves; they require some other form of energy such as ultraviolet light to “excite” them. One manufacturer of suitable fluorescent pigments that can be used in the disclosed embodiments is Glow, Inc. Severn, Md.

In some embodiments a phosphorescent compound is used. Phosphorescence is just like fluorescence, except that the glow continues even after the light used to excite it is removed. “Glow in the dark” toys phosphoresce brightly in total darkness after being “charged” or excited by ordinary white or ultraviolet light. Glow powder works by absorbing surrounding light energy and then releases that energy when the lights go out. Glow powder is typically made with zinc sulfide or other methods like strontium aluminate pigments.

In some embodiments, a first portion of the graphic has a first degree of transparency and a second portion of the graphic has a second degree of transparency, where the first degree of transparency is different than the second degree of transparency. In fact, the graphic can have any number of different portions, each with an independent, and quite possibly unique, degree of transparency. Moreover, the graphic can have any number of different portions, each with an independent, and quite possibly unique, color. For example, in some embodiments, the graphic is a CMYK graphic.

As described below, in various embodiments, graphic is incorporated into the material of the deck 105 (e.g., by water transfer imaging, as described below). Alternatively, in some embodiments, graphic 802 is printed (e.g., digitally printed with high resolution) onto an adhesive surface of a grip tape that is applied to the top surface 150 (FIG. 1) of deck 105.

In some embodiments the graphic is transferred onto the top surface 150 or, more preferably, the bottom surface using hydrographics, also known as water transfer imaging. In one such process, the deck 105 is pre-treated and a base coat material is applied. A polyvinyl alcohol film is gravure-printed with the graphic image to be transferred, and is then floated on the surface of a vat of water. An activator chemical is sprayed on the film to dissolve it into a liquid and activate a bonding agent. The deck 105 is then lowered into the vat, through the floating ink layer, which wraps around and adheres to it. After removing the deck 105 from the water, a top coat is applied to protect the design. A kit for performing such a transfer is disclosed in U.S. Pat. No. 8,360,239, which is hereby incorporated by reference herein in its entirety.

Alternatively, in some embodiments, the graphic is applied to the top surface 150 via a grip tape having the graphic printed thereon. An example of grip transparent or translucent grip tapes, albeit not illuminated, is described in U.S. Pat. No. 7,897,233 granted to Esposito et al. and entitled “Adhesive Antiskid Sheet with Integrated Graphics Features,” which is hereby incorporated by reference in its entirety.

In some embodiments, the transparent or translucent wheel covering 200 has an opaque patterning, such as stripes in order to create a special effect as the wheels rotate. In some embodiments, rather than an opaque patterning the wheel covering 200 is transparent but has a translucent patterning in order to create a special effect.

In some embodiments, an intensity of a light emitted by the plurality of light emitting devices 230 is determined by an amount of electricity generated by the wheel generator. In such embodiments, an amount of electricity generated by the corresponding wheel generator is determined by a speed with which the corresponding wheel 203/204 rotates about the corresponding rotational axis. However, in some embodiments, the wheel generator is not operated by electromagnetic induction but rather is battery powered. In such embodiments, the wheel generator is controlled between at least an electricity producing state and an off state by a manually operated switch (not shown) electrically coupled to the wheel generator and the corresponding plurality of light emitting devices 230 of a given wheel. In some embodiments, the switch provides for additional states, such as a bright light setting and a dim light setting. In embodiments having a switch, the switch is mounted on a wheel covering 200 in a region that does not get exposed to pavement or other riding surfaces.

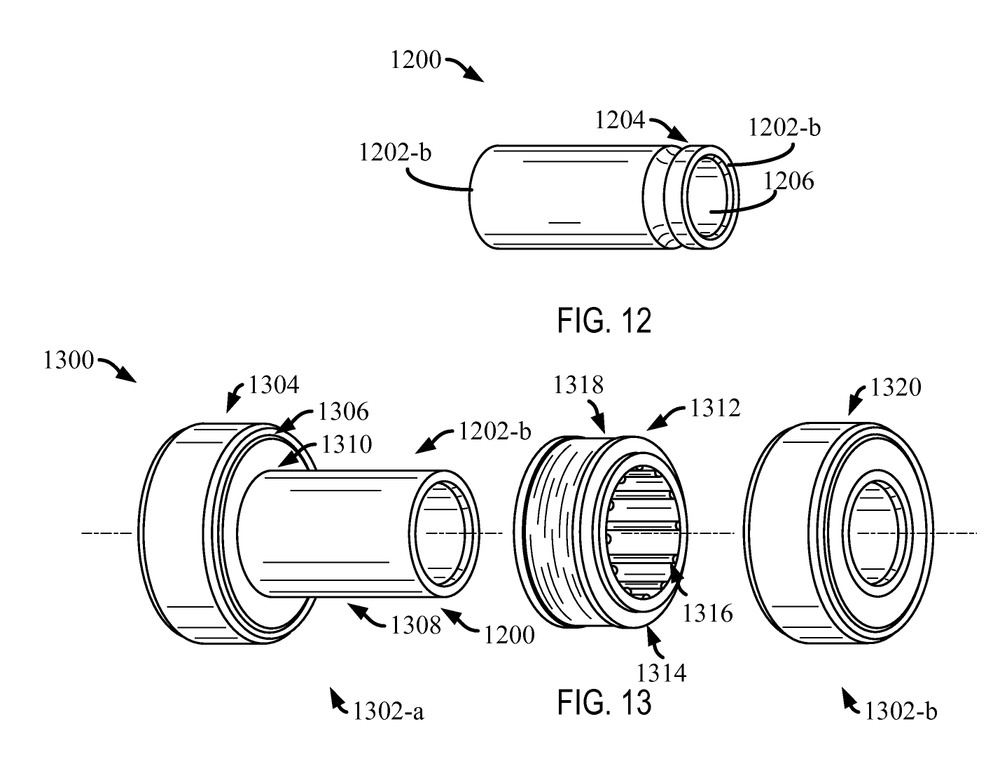

FIG. 12 is an illustration of an inner race 1200 of a bearing, in accordance with some embodiments. Inner race 1200 is characterized by first end 1202-a and second end 1202-b. Inner race 1200 includes groove 1204 configured to receive rolling elements of a rolling element bearing and provide a track for the movement of said rolling elements in order to facilitate the rotational functionality of the rolling element bearing. For example, in some embodiments, inner race 1200 is an inner race of a ball bearing and groove 1204 is configured to receive balls. Inner race 1200 has an inner bore 1206 that receives an axle (e.g., inner bore 1206 at least partially defines a hub for an axle). In some embodiments, inner bore 1206 is sized such that, in use (e.g., when bearing a portion of the weight of a skateboard rider), inner race 1200 is rotationally fixed with respect to the axle (e.g., with little or no rotational slippage between the axle and inner race 1200). When used in conjunction with a skateboard truck, inner race 1200 does not rotate while the wheel is rotating, resulting in rotational displacement between inner race 1200 and the wheel. The advantages of such an inner race, e.g., when incorporated into a wheel assembly for generating electricity, are discussed with reference to FIG. 13.

In some embodiments, inner race 1200 is made of a first material such as a ceramic, a metal or a metal alloy. For example, in various embodiments, inner race 1200 is made of carbon steel, stainless steal, chrome steel, and/or ceramic silicon nitride (Si₃N₄), to name a few. Further, groove 1204 is offset (e.g., asymmetrically) toward the first end 1202-a. The reason for the offset is to provide a portion of inner race that will protrude on one side beyond an outer race of a bearing, as described with reference to FIG. 13.

FIG. 13 is an expanded illustration of a hub 1300, in accordance with some embodiments. Hub 1300 provides a magnetic unit secured to an inner race of a bearing such that it is rotationally fixed with respect to the inner race. Thus, the magnetic unit together with the inner race is free to rotate with respect to an outer race. Stated another way, when the outer race rotates with a wheel attached thereto, the inner race together with the magnetic unit stays rotationally stationary. Magnetic flux from the wheel rotating (e.g., spinning) around the magnetic unit is used to generate electricity (e.g., by coils of wire rotationally fixed with respect to, e.g., rotating with, the outer race). The electricity can be used for any number of purposes, such as powering light sources to illuminate a skateboard or graphics printed on or applied to the skateboard. Hub 1300 may be used in a wheel assembly for use in any of the skateboards described herein.

As used herein, the term “hub” is intended to mean a mechanical component and/or apparatus that facilitates rotational movement of a mechanical member (e.g., an axle, axle bolt, spindle, or skewer). For example, in some embodiments, hub 1300 is, or is a component of, a wheel assembly (e.g., a wheel assembly for a skateboard wheel). In some embodiments, hub 1300 is, or is a component of, a headstock and/or a bottom bracket (e.g., on a bicycle). In some embodiments, hub 1300 is configured to receive an axle, axle bolt, spindle, or skewer. In various embodiments, hub 1300 is used to facilitate rotational movement of a component (e.g., a wheel or other rotating component) of a skateboard, a unicycle, a bicycle, a tricycle, a handcycle, a wagon (e.g., a child's toy wagon), a scooter, a paddleboard, paddleboat, and/or a child's toy (e.g., a toy car or toy truck). For the sake of explanation, hub 1300 is described below as a wheel assembly for a skateboard. But one of ordinary skill in the art will recognize other uses for hub 1300 (e.g., as a component in other types of vehicle or apparatus, such as those listed above).

Hub 1300 includes first bearing 1302-a and second bearing 1302-b. Second bearing 1302-b is axially aligned with the first bearing to form a hub for an axle (e.g., first bearing 1302-a and second bearing 1302-b share a common axis of rotation). The first bearing includes outer race 1304. Outer race 1304 is characterized by (e.g., has) an inner surface 1306 with respect to the axial alignment of the first bearing and the second bearing. Stated another way, inner surface 1306 faces second bearing 1302-b. Hub 1300 includes inner race 1200 (FIG. 12). Inner race 1200 has a portion 1308 that axially extends beyond inner surface 1306 of outer race 1304 to at least partially define the hub (e.g., hub 1300 is configured such that an axle, or axle bolt, passes through inner race 1200). First bearing 1302-a optionally includes one or more shields 1310 which complete the casing (e.g., housing) of bearing 1302-a (e.g., shields 1310 complete the casing of the moving components of bearing 1302-a, such as the balls). For example, in some embodiments, second end 1202-b extends beyond shield 1310 while first end 1202-a and groove 1204 are an encased portions of first bearing 1302-a.

Hub 1300 also includes a magnetic unit 1312 securely coupled with the portion 1308 of inner race 1200 that extends axially (protrudes) beyond inner surface 1306 of outer race 1304. In some embodiments, magnetic unit includes an insert 1314 that fits snuggly on the portion 1308 of inner race 1200 that extends axially beyond inner surface 1306 of outer race 1304. In some embodiments, insert 1314 is made of a second material that is less hard than the first material from which inner race 1200 is made. Stated another way, the first material is harder than the second material. For example, in some embodiments, insert 1314 is made of a plastic such as polyurethane (PU). In some embodiments, only a portion of insert 1314 is made of the second material. For example, in some embodiments, at least an inner annular surface 1316 is made of the second material. In this case, inner annular surface 1316 of the magnetic unit is inserted over and securely coupled with an outer annular surface of the portion of the inner race. In some embodiments, inner annular surface 1316 of magnetic unit 1312 is press-fit onto the outer annular surface of the portion 1308 of inner race 1200. Magnetic unit 1312 includes a magnet 1318 (e.g., a ferromagnetic) disposed at least partially circumferentially around the insert 1314 (e.g., transcribing an arc at least partially or entirely spanning the circumference of insert 1314).

In some embodiments, second bearing 1302-b includes an inner race. When in use, the inner race of second bearing 1302-b is securely coupled with inner race 1200 of first bearing 1302-a by an axle unit (e.g., a quick release skewer, an axle bolt, etc.) that includes an axle disposed within the hub and two or more mechanical fasteners (e.g., nuts, bolts, and/or wingnuts) along the axle on each side of the hub (e.g., to clamp hub 1300 together). Stated another way, in some embodiments, hub 1300 is clamped together by an axle unit.

In some embodiments, hub 1300 is a component in a wheel assembly that includes a wheel (FIG. 16) coupled with outer race 1304 of first bearing 1302-a. In some embodiments, the wheel is also coupled with outer race 1320 of second bearing 1302-b. As used herein, the term “coupled with” is intended to mean that there is a mechanical coupling between two components (e.g., members) of a mechanical apparatus. In particular, the term “coupled with” is intended to be broader than the term “connected to” because the term “coupled with” is intended to cover indirect couplings. For example, two plates may be “coupled with” one another even if the two plates are separated by a spacer (e.g., the two plates need not be in direct contact). In some embodiments, the term “coupled with” is intended to mean fixedly coupled with, which in turn means that there is at least one degree of freedom (e.g., a translational or rotation degree of freedom) that is fixed between the two components. For example, in some embodiments, the wheel rotates together with outer race 1304, and is thus fixedly coupled with outer race 1304 because a rotational degree of freedom is fixed between the wheel and outer race 1304 (as well as other degrees of freedom).

The wheel has one or more wire coils that are configured to generate electricity with magnetic unit 1316 when the wheel spins. To this end, the one or more wire coils harness magnetic flux from the magnetic unit 1316 as the one or more wire coils spin around the magnetic unit 1316. In the case of a skateboard wheel assembly utilizing hub 1300, skateboarder driven rotation of the wheel produces magnetic flux which is capture by the wire coils and inductively converted to electricity (e.g., by virtue of Faraday's law of induction). The rotational rigidity of magnetic unit 1316, inner race 1200, and an axle disposed within hub 1300 optimizes the rotation, and hence optimizes the magnetic flux captured by the coils which results in greater generation of electricity. The axial rigidity of the first material (being a hard material such as a metal alloy or ceramic material) provides enhanced mechanical performance and responsiveness of the wheel assembly as a whole (e.g., to a skateboarder's maneuvering).

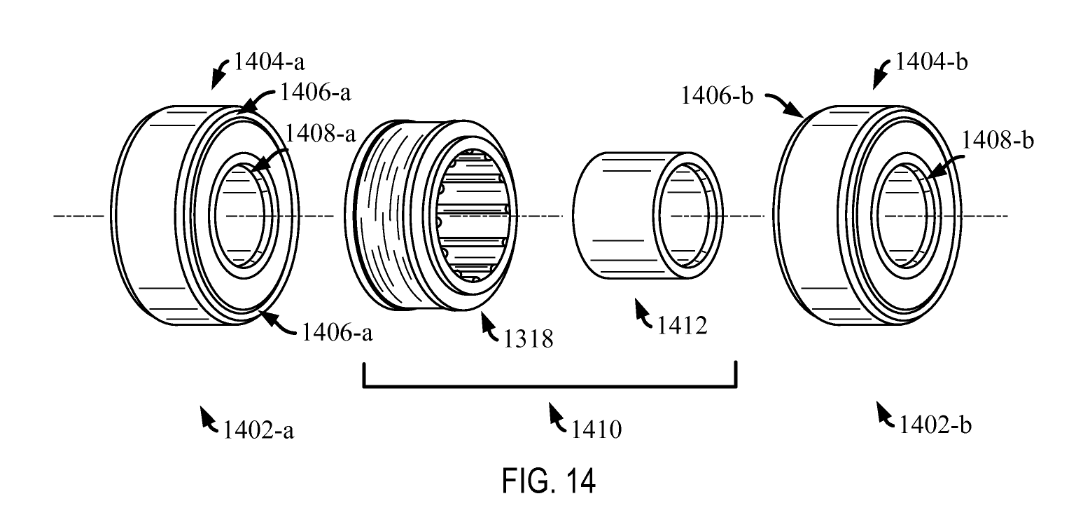

FIG. 14 is an expanded illustration of a hub 1400, in accordance with some embodiments. Hub 1400 is an alternative to hub 1300. Hub 1400 provides a magnetic unit secured to a spacer that is clamped between respective inner races of two bearing such that the magnetic unit is rotationally fixed with respect to the inner races (and, optionally, an axle passing through said inner races). Thus, the magnetic unit together with the inner races is free to rotate with respect to respective outer races of the bearings. Magnetic flux from a rotating (e.g., spinning) wheel revolving around the magnetic unit is used generate electricity (e.g., by coils of wire rotationally fixed with respect to the outer race). The electricity can be used for any number of purposes, such as powering light sources to illuminate a skateboard. Hub 1400 may be used in a wheel assembly for use in any of the skateboards described herein.

Hub 1400 includes a first bearing 1402-a and a second bearing 1402-b. Second bearing 1402-b is axially aligned with the first bearing to form a hub for an axle (e.g., first bearing 1402-a and second bearing 1402-b share a common axis of rotation given by the axial alignment). Each of the first bearing and the second bearing includes an outer race 1404 (first bearing 1402-a includes outer race 1404-a and second bearing 1402-b includes outer race 1404-b). Outer race 1404-a has an inner surface 1406-a with respect to the axial alignment of the first bearing and the second bearing; and outer race 1404-b has an inner surface 1406-b with respect to the axial alignment of the first bearing and the second bearing (e.g., the inner surfaces 1406 face one another). Each bearing 1402 also includes an inner race 1408 (e.g., inner race 1408-a and inner race 1408-b) that at least partially defines the hub for the axle (e.g., the axle space). In some embodiments, each bearing 1402 shown in FIG. 14 is a standard, off-the-shelf bearing, such as the SUPER SWISS 6 BALL BEARINGS produced by BONES BEARINGS.

Hub 1400 also includes a spacer 1410 disposed between the respective inner surfaces 1406 of outer race 1404-a and the outer race 1404-b. Spacer 1410 is considered the respective inner surfaces 1406 when it is disposed between a plane defined by each respective surface, even if spacer 1410 does not overlap with the respective inner surfaces of either outer race 1404. Spacer 1410 includes a cylinder 1412 made of a first material (e.g., a hard material such as a metal, metal alloy, or ceramic). Cylinder 1412 is axially aligned with first bearing 1404-a and second bearing 1404-b. Spacer 1410 also includes magnetic unit 1318 securely coupled with an outer annular surface of cylinder 1412. Magnetic unit 1318 is described in detail with reference to FIG. 13. An inner angular surface of the magnetic unit is made of a second material (e.g., a soft material) different from the first material. Suitable first materials are also described with reference to FIG. 13. In some embodiments, this combination of materials provides a secure press-fit between cylinder 1412 and magnetic unit 1318.

In some embodiments, hub 1400 is used in a wheel assembly that includes a wheel coupled with the respective outer races of the first bearing and the second bearing. As described with reference to FIG. 13, the wheel has one or more wire coils that are configured to generate electricity with the magnetic unit when the wheel spins. When in use, spacer 1410 is securely coupled with the inner races of the first bearing and the second bearing to further define the hub for the axle. In some embodiments, spacer 1410 is securely clamped between the inner races of the first bearing and the second bearing. This has the advantage of fixing magnetic unit 1318 with respect to the rotation of the wheel, which is advantageous for generation of electricity. Because of the hard first material used to make spacer 1410, the axial rigidity of the first material (being a hard material such as a metal alloy or ceramic material) provides enhanced mechanical performance and responsiveness of the wheel assembly as a whole (e.g., to a skateboarder's maneuvering).

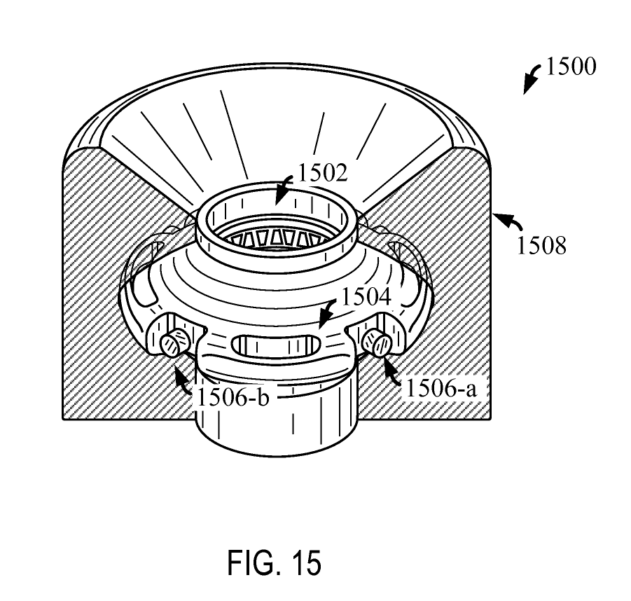

FIG. 15 is an illustration of a wheel 1500 that receives a hub (e.g., receives hub 1300 or hub 1400 to form a wheel assembly), in accordance with some embodiments. For example, in some embodiments, a wheel assembly is formed when hub 1300 or hub 1400 is disposed within space 1502 (e.g., a bore) of wheel 1500. Moreover, wheel 1500 is just one example of a wheel that can be used to form a wheel assembly; more generally, any of the wheels or wheel components described here or elsewhere in this document (e.g., with reference to FIGS. 9-11) may be used, in accordance with a variety of embodiments, to form a wheel assembly. In some embodiments, the wheel is a skateboard wheel (e.g., the wheel assembly is for use on a skateboard). Also, in some circumstances, a skateboard wheel may be considered as including a hub. But for the sake of explanation only, the wheel and the hub are described separately herein.

In some embodiments, wheel 1500 is coupled with the respective outer race of one or more bearings. The wheel has one or more wire coils (not shown) that are internal to an electronics device 1502. The one or more wire coils are configured to generate electricity with a magnetic unit when the wheel spins, as described with reference to FIGS. 13 and 14. The wheel also includes a plurality of light sources 1506 (e.g., including light sources 1506-a and 1506-b) configured to produce light using the generated electricity. In some embodiments, the plurality of light sources includes four light sources. In some embodiments, the light sources are light emitting diodes. Wheel 1500 includes body 1508 made of a transparent material and the plurality of light sources is disposed within the body of the wheel so as to shine light outwardly from the wheel. For example, in some embodiments, the plurality of light sources is used to illuminate graphics (e.g., fluorescent graphics) on a skateboard deck, as described elsewhere in this document. In some embodiments, body 1508 is made of a clear cast resin, such as a clear cast polyurthane (PU).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A wheel assembly comprising:
a first bearing and a second bearing that is axially aligned with the first bearing to form a hub for an axle, wherein the first bearing includes:
an outer race having an inner surface with respect to the axial alignment of the first bearing and the second bearing, and
an inner race having a portion axially extending beyond the inner surface of the outer race to at least partially define the hub;
a magnetic unit securely coupled with the portion of the inner race axially extending beyond the inner surface of the outer race; and
a wheel coupled with the respective outer race of the first bearing, the wheel having one or more wire coils that are configured to generate electricity with the magnetic unit when the wheel spins.

2. The wheel assembly of claim 1, wherein:
the second bearing includes an inner race; and
when in use, the inner race of the second bearing is securely coupled with the inner race of the first bearing by an axle unit that includes an axle disposed within the hub and two or more mechanical fasteners along the axle on each side of the hub.

3. The wheel assembly of claim 1, wherein the wheel assembly is for a skateboard.

4. The wheel assembly of claim 1, further including a plurality of light sources configured to produce light using the generated electricity.

5. The wheel assembly of claim 4, wherein the wheel includes a body made of a transparent material and the plurality of light sources is disposed within the body of the wheel so as to shine light outwardly from the wheel.

6. The wheel assembly of claim 1, wherein:
the portion of the inner race includes an outer annular surface made of a first material;
the magnetic unit includes an inner annular surface made of a second material different from the first material; and
the inner annular surface of the magnetic unit is securely coupled with the outer annular surface of the portion of the inner race.

7. The wheel assembly of claim 6, wherein inner annular surface of the magnetic unit is press-fit onto the outer annular surface of the portion of the inner race.

8. The wheel assembly of claim 6, wherein the first material is harder than the second material.

9. The wheel assembly of claim 1, wherein:
the magnetic unit is rotationally fixed with respect to the inner race; and
the magnetic unit together with the inner race is free to rotate with respect to the outer race.

10. A wheel assembly comprising:
a first bearing and a second bearing that is axially aligned with the first bearing to form a hub for an axle, wherein each of the first bearing and the second bearing includes:
an outer race having an inner surface with respect to the axial alignment of the first bearing and the second bearing; and
an inner race that at least partially defines the hub;
a spacer disposed between the respective inner surfaces of the outer race of the first bearing and the outer race of the second bearing, the spacer including:
a cylinder made of a first material, wherein the cylinder is axially aligned with the first bearing and the second bearing; and
a magnetic unit securely coupled with an outer annular surface of the cylinder, wherein an inner angular surface of the magnetic unit is made of a second material different from the first material;
a wheel coupled with the respective outer races of the first bearing and the second bearing, the wheel having one or more wire coils that are configured to generate electricity with the magnetic unit when the wheel spins;
wherein, when in use, the spacer is securely coupled with the inner races of the first bearing and the second bearing to further define the hub.

11. The wheel assembly of claim 10, when in use, the inner race of the second bearing is securely coupled with the inner race of the first bearing by an axle unit that includes an axle disposed within the hub and two or more mechanical fasteners along the axle on each side of the hub.

12. The wheel assembly of claim 10, wherein the wheel assembly is for a skateboard.

13. The wheel assembly of claim 10, further including a plurality of light sources configured to produce light using the generated electricity.

14. The wheel assembly of claim 13, wherein the wheel includes a body made of a transparent material and the plurality of light sources is disposed within the body of the wheel so as to shine light outwardly from the wheel.

15. The wheel assembly of claim 10, wherein the inner annular surface of the magnetic unit is press-fit onto the outer annular surface of the portion of the inner race.

16. The wheel assembly of claim 10, wherein the first material is harder than the second material.

17. The wheel assembly of claim 10, wherein:
the magnetic unit is rotationally fixed with respect to the inner race of each of the first bearing and the second bearing; and
the magnetic unit together with the inner race of each respective bearing is free to rotate with respect to the outer race of the respective bearing.
